(19) United States
(12) Patent Application Publication
(10) Pub. No.: US 2015/0125762 A1
(43) Pub. Date: May 7, 2015

(54) LITHIUM ELECTROCHEMICAL STORAGE BATTERY OF THE LITHIUM/AIR TYPE

(71) Applicant: COMMISSARIAT A L'ENERGIE ATOMIQUE ET AUX ENERGIES ALTERNATIVES, Paris (FR)

(72) Inventors: Charles Gayot, Grenoble (FR); Sophie Mailley, Le Pin (FR); Lionel Picard, Seyssinet (FR); Jean-Frederic Martin, Grenoble (FR)

(21) Appl. No.: 14/397,101

(22) PCT Filed: Apr. 23, 2013
(86) PCT No.: PCT/EP2013/058354

§ 371 Date: Oct. 24, 2014

(30) Foreign Application Priority Data
Apr. 25, 2012 (FR) 12 53791

(51) Int. Cl. H01M 12/08; H01M 4/90; H01M 4/136; H01M 4/38; H01M 4/62; H01M 4/587; H01M 4/133; H01M 4/134; H01M 4/86; H01M 4/58

(52) U.S. Cl. CPC H01M 12/08; H01M 4/8673; H01M 4/9041; H01M 4/9016; H01M 4/8668; H01M 4/9075; H01M 4/9083; H01M 4/136; H01M 4/5825; H01M 4/623; H01M 4/625; H01M 4/587; H01M 4/133; H01M 4/134; H01M 4/38; H01M 2300/0025; H01M 2004/027
USPC 429/405

(57) ABSTRACT

A lithium-air storage battery having at least one electrochemical cell with
a negative electrode, which is an air electrode;
a positive electrode, which comprises a material for insertion of lithium; and
an organic electrolyte conducting lithium ions, positioned between the negative electrode and positive electrode, the electrolyte not degrading, when it is subject to a voltage ranging from 3V to 5.5V expressed relatively to the Li⁺/Li pair and the storage battery having a potential difference between the electrochemical potential of the positive electrode and the electrochemical potential of the negative electrode greater than 4.5V expressed relatively to the Li⁺/Li pair.

### TECHNICAL FIELD

The present invention relates to a lithium electrochemical storage battery of the lithium-air type comprising, within a cell, an original association between a positive electrode material and a negative electrode material, this association having the consequence of resulting in a more secure storage battery and the reactions of which at the electrodes are easily reversible.

The field of the invention may thus be defined as that of energy storage devices, in particular that of electrochemical storage batteries of the lithium-air type.

### STATE OF THE PRIOR ART

Energy storage devices are conventionally electrochemical storage batteries operating on the principle of electrochemical cells able to deliver an electric current by the presence in each of them of a pair of electrodes (a positive electrode and a negative electrode, respectively) separated by an electrolyte, the electrodes comprising specific materials able to react according to an oxidation-reduction reaction, in return for which there is production of electrons at the origin of the electric current and production of ions which will circulate from one electrode to the other through an electrolyte.

Devices of this type may be lithium-air storage batteries, which conventionally at each basic electrochemical cell consists of a negative electrode formed with a material based on lithium, which may either be lithium metal or an alloy based on lithium, as specified in FR 2 941 091, and a positive electrode of the air electrode type separated by an electrolyte conducting lithium ions.

The operation of an electrochemical cell of an air-lithium storage battery, is more specifically based on reduction of the oxygen at the positive electrode by the Li⁺ ions present in the electrolyte and stemming from the negative electrode and on oxidation of the lithium metal at the negative electrode during the discharge process, the reactions occurring at the electrodes may be symbolized by the following electrochemical equations:
*at the positive electrode (air electrode):

2Li⁺+2e⁻+O₂ (g)→Li₂O₂ (s) (2.91 V vs. Li⁺/Li)

2Li⁺+2e⁻+(½)O₂(g)→Li₂O(s) (3.10 V vs. Li⁺/Li)
*at the negative electrode:

Li₍ₛ₎→Li⁺+e⁻

The main obstacles of lithium-air technology are the following:
the safety of the storage battery;
the reversibility of the electrochemical reactions at the electrodes.

Indeed, as regards the safety of the storage battery, the latter essentially results from the use of lithium metal or of a lithium alloy at the negative electrode, which, during the discharge process, migrates and reacts with oxygen in order to form lithium peroxide and, during the charging process, may be at the origin of the creation of lithium dendrites.

These lithium dendrites generate the following drawbacks:
they may short-circuit the storage battery and thus are a hazard to the user;
they may also contribute to greatly reducing the cyclability of the storage battery, from the moment that the electric contact between the lithium and the adjacent current collector worsens, gradually as the number of cycles increase;
they may contribute to inevitably damaging the negative electrode, which induces a consequent limitation of the cyclability of the storage battery (the latter may be limited to about 50, which does not allow sustained use of the latter).

As regards the reversibility of the electrochemical reactions at the electrodes, it should be noted that the discharged products, such as Li₂O₂ or Li₂O, which are insoluble are led to being deposited in the porosity of the air electrode, compromising reversibility of the reactions and consequently, the cycling strength of the storage battery.

Several solutions have been proposed for improving safety and the cyclability of storage batteries, notably:
depositing a ceramic conducting lithium, as described in US 2005/095506;
using a polymeric membrane impregnated with an electrolyte placed on the lithium, as described in US 2007/0051620;
using ion conducting liquids, as described in US 2010/0327811.

The inventors of the present invention set the goal of proposing a novel architecture of lithium-air storage batteries comprising an original association between a specific positive electrode and a specific negative electrode, which have a safety aspect and for which the reactions at the electrodes are easily reversible.

### DISCUSSION OF THE INVENTION

Thus, the invention relates to a lithium-air storage battery comprising at least one electrochemical cell comprising:
a negative electrode which is an air electrode;
a positive electrode, which comprises a material for insertion of lithium; and
an organic electrolyte conducting lithium ions positioned between said negative electrode and said positive electrode, said electrolyte not degrading, when it is subject to a voltage ranging from 3V to 5.5V expressed relatively to the Li⁺/Li pair, preferably from 4.5V to 5.5V, and said accumulator being characterized by a potential difference between the electrochemical potential of the positive electrode and the electrochemical potential of the negative electrode greater than 4.5V expressed relatively to the Li⁺/Li pair.

By means of the different constitutive elements of said cell, the following are obtained:
an improvement in the reversibility of the electrochemical reactions occurring at the electrodes because of the use of a lithium insertion material in order to form the positive electrode, which gives the possibility of consequently ensuring better cyclability;
increased safety because lithium metal is no longer used for entering the structure of one of the electrodes, said lithium metal is at the origin of the formation of dendrites responsible for short-circuits within the storage battery.

Before going into more details in the discussion of this invention, we specify the following definitions.

In the foregoing and in the following, it is specified that the voltages or potentials are expressed relatively to the reference pair Li⁺/Li. This pair has an oxidation-reduction potential of −3.02V relatively to the normal hydrogen electrode (NHE).

By positive electrode, from the foregoing and from the following, is conventionally meant the electrode which acts as a cathode, when the storage battery produces current (i.e. when it is in a discharge process) and which acts as an anode when the accumulator is in a charging process.

By negative electrode in the foregoing and in the following, is conventionally meant that the electrode which acts as an anode, when the storage battery produces current (i.e. when it is in a discharge process) and which acts as a cathode, when the storage battery is in a charging process.

As mentioned earlier, the negative electrode of the storage battery of the invention is an air electrode, which is conventionally used in storage batteries from the prior art as a positive electrode and not as a negative electrode as this is the case of the invention.

At this air electrode, the oxygen is reduced during the charging of the cell according to the following electrochemical equations:

2Li⁺+2e⁻+O₂ (g)→Li₂O₂ (s)

2Li⁺+2e⁻+(½)O₂(g)→Li₂O(s)

The air electrode is intended to be in direct contact with air, in order to allow reduction of oxygen and therefore should conventionally have catalytic sites and allow the exchange of electrons, which is expressed by the following properties:
diffusion of oxygen in gaseous form;
electron conductivity;
large catalytic surface area;
good wettability by the organic electrolyte;
good mechanical strength.

From a structural point of view, an air electrode capable of entering the structure of a storage battery according to the invention may comprise:
at least one electron conducting material;
at least one catalyst; and
optionally at least one binder for ensuring cohesion between said material and said catalyst.

The electron conducting material may preferably be a carbonaceous material, i.e. a material comprising carbon in the elementary state.

As a carbonaceous material mention may be made of:
graphite;
mesocarbon beads;
carbon fibers;
carbon black such as acetylene black, channel black, furnace black, lamp black, anthracene black, coal black, gas black, thermal black;
graphene; and
mixtures thereof.

The electron conducting material may also be an electron conducting ceramic belonging to the families of transition element nitrides, such as TiN, carbides of transition element(s) and/or of metalloid element(s), such as TiC, SiC, carbonitrides of transition element(s), such as TiCN, simple oxides of transition element(s), such as TiO and ZnO.

It is not excluded that the electron conducting material may both contain a carbonaceous material as mentioned above and an electron conducting ceramic, as mentioned above.

The aforementioned catalyst from a functional point of view is a catalyst able to accelerate the electrochemical reactions occurring at the air electrode (whether during a discharging or charging process) and also able to increase the operational voltage, at which these electrochemical reactions occur.

A catalyst fitting these specificities may be:
a catalyst consisting of a noble metal with an oxidation degree of 0, such as platinum or palladium or a noble metal alloy with another metal element, such as a Pt—Fe alloy;
a catalyst comprising a simple ruthenium oxide, such as RuO₂, a simple manganese oxide, such as MnO₂, Mn₂O₂, a simple iron oxide such as Fe₃O₄, Fe₂O₃, a simple cobalt oxide, such as Co₃O₄ or a simple copper oxide, such as CuO; or
a catalyst comprising a mixed cobalt oxide, such as CoFe₂O₄, a mixed manganese oxide, such as LaMnO₂, a mixed nickel oxide, such as LaNiO₃; and
mixtures thereof.

Preferably, the catalyst used according to the invention is a mixed or simple manganese oxide, a mixed or simple iron oxide, a mixed or simple iron oxide or mixtures thereof.

In order to ensure cohesion between the electron conducting material and the catalyst, the negative electrode may comprise one or several binders, in particular one or several polymeric binders.

Among the polymeric binders which may be used, mention may be made of:
*fluorinated optionally proton conducting (co)polymers, such as:
fluorinated polymers, such as polytetrafluoroethylene (known under the acronym of PTFE), a polyvinylidene fluoride (known under the acronym of PVDF);
fluorinated copolymers, such as poly(vinylidene fluoride-co-hexafluoropropene) (known under the acronym of PVDF-HFP);
proton conducting fluorinated polymers, such as Nafion®;
* elastomeric polymers, such as a styrene-butadiene copolymer (known under the acronym of SBR), an ethylene-propylene-diene monomer copolymer (known under the acronym of EPDM); polymers from the family of polyvinyl alcohols;
* cellulose polymers, such as sodium carboxymethylcellulose; and
* mixtures thereof.

Preferably, the binder used is a binder based on a fluorinated polymer, such as a polytetrafluoroethylene, a polyvinylidene fluoride and mixtures thereof, this type of binder giving the possibility of obtaining a good percolating lattice.

In the negative electrode, the electron conducting material as defined above may be present in a proportion ranging from 40 to 97% by mass based on the total mass of the mixture comprising said material and said binder(s) (which as a counterpart means that the binder(s) may be present in a proportion ranging from 3 to 60% by mass based on the total mass of the aforementioned mixture).

In addition to the presence of at least one electron conducting material, of at least one catalyst and optionally at least one binder, the negative electrode may also comprise a support, intended, as indicated by its name, for supporting the aforementioned ingredients, this support may further contribute to ensuring good mechanical strength of the electrode and good electron conduction and allow diffusion of gases, in particular oxygen. This electrode may thus be described as a supported electrode.

This support may appear as a foam, a grid or further a fibrous support and may be in a material comprising a metal or a metal alloy or further in a carbonaceous material.

Most particularly, this may be a carbon support, a titanium support, a palladium support, a copper support, a gold support, an aluminum support, a nickel support or a stainless steel support.

According to a particular embodiment of the invention, the negative electrode comprises a grid or foam in nickel used as a support for a composition comprising carbon black (acting as an electron conducting material), PVDF (acting as a binder) and manganese oxide (acting as a catalyst), the manganese oxide may appear in the form of nanowires.

As mentioned above, the positive electrode comprises a material for lithium insertion, the discharge voltage of which is greater than 4.5V expressed relatively to the Li⁺/Li pair.

A material meeting this specificity may be a material of the lithiated material type with a spinel structure, this material being known under the name of <<5V spinel>>.

More specifically, this may be a material fitting the following characteristics:
a material of formula LiM¹PO₄, wherein M¹ is a transition element, materials of this type may be LiCoPO₄ or LiNiPO₄;
a material of formula LiM²SO₄X¹, wherein M² is a transition element and X¹ is a halogen element, materials of this type may be LiCoSO₄F, LiNiSO₄F;
a material of formula Li₂M³PO₄X², wherein M³ is a transition element and X² is a halogen element, materials of this type may be Li₂CoPO₄F, Li₂NiPO₄F; or
a material of formula LiMn₂₋ₓM⁴ₓO₄, wherein M⁴ is a transition element selected from Ni, Fe, Co and mixtures thereof and x is comprised between 0.5 and 1, a material of this type may be LiMn_{1.5}Ni_{0.5}O₄.

In addition to the presence of a material for lithium insertion, the positive electrode may comprise:
at least one electron conducting material;
at least one binder for ensuring the cohesion between said material for lithium insertion and said electron conducting material; and
optionally electron conducting fibers.

The electron conducting material may preferably be a carbonaceous material, i.e. a material comprising carbon in the elementary state.

As a carbonaceous material mention may be made of carbon black.

The binder may preferably be a polymeric binder.

Among the polymeric binders which may be used, mention may be made of:
* fluorinated (co)polymers which are optionally proton conductors, such as:
fluorinated polymers, such as a polytetrafluoroethylene (known under the acronym of PTFE), a polyvinylidene fluoride (known under the acronym of PVDF);
fluorinated copolymers such as a poly(vinylidene fluoride-co-hexafluoropropene) (known under the acronym of PVDF-HFP);
proton conducting fluorinated polymers such as Nafion®;
   * elastomeric polymers, such as a styrene-butadiene copolymer (known under the acronym of SBR), an ethylene-propylene-diene monomer copolymer (known under the acronym of EPDM);
   *polymers from the family of polyvinyl alcohols; and
   * mixtures thereof.

Electron conducting fibers when they are present, may further participate in the good mechanical strength of the positive electrode and are selected for this purpose so as to have a very large Young modulus. Fibers adapted to this specificity may be carbon fibers, such as carbon fibers of the Tenax® or VGCF-H® type. Tenax® carbon fibers contribute to improving the mechanical properties and have good electric conductivity. VGCF-H® carbon fibers are steam synthesized fibers and contribute to improving the thermal and electric properties, the dispersion and the homogeneity.

In addition to the presence of at least one material for lithium insertion, of at least one electron conducting material, of at least one binder and optionally of electron conducting fibers, the positive electrode may also comprise a support, intended, as indicated by its name, for supporting the aforementioned ingredients, this support may further ensure good mechanical strength of the electrode and good electron conduction. The electrode may thus be described as a supported electrode.

This support may appear as a foam, a grid or further a fibrous support and may be in a material comprising a metal or a metal alloy or further in a carbonaceous material.

Most particularly, this may be a carbon support, a titanium support, a palladium support, a copper support, a gold support, an aluminum support, a nickel support or a stainless steel support.

According to a particular embodiment of the invention, the positive electrode comprises an aluminum grid acting as a support, on which is deposited a composition comprising a material of formula LiMn_{1.5}Ni_{0.5}O₄ (acting as a material for lithium insertion), carbon black (acting as an electron conducting material), PVDF (acting as a binder) and carbon fibers (acting as electron conducting fibers).

The electrolyte intended for entering the structure of the storage batteries of the invention is a lithium ion conducting organic electrolyte positioned between said negative electrode and said positive electrode, said electrolyte not degrading, when it is subject to a voltage ranging from 3V to 5.5V expressed relatively to the Li⁺/Li pair, which means that it retains its properties intact after having been subject to such a voltage.

An electrolyte fitting this specificity may be an electrolyte comprising:
a lithium salt;
at least one organic solvent belonging to the family of carbonate solvents, sulfone solvents or lactone solvents; and
optionally a stabilization additive belonging to the family of phosphates or anhydride compounds.

As examples, the lithium salt may be selected from the group formed by LiPF₆, LiClO₄, LiBF₄, LiAsF₆, LiCF₃SO₃, LiN (CF₃SO₂)₃, LiN(C₂F₅SO₂), lithium bis(trifluoromethylsulfonyl)imide (known under the acronym of LiTFSI) LiN[SO₂CF₃]₂, lithium bis(oxalato)borate (known under the acronym of LIBOB), lithium bis(fluorosulfonyl)imide (known under the acronym of LiFSI), LiPF₃(CF₂CF₃)₃ (known under the acronym of LiFAP), lithium trifluoromethanesulfonate (known under the acronym of LiTf), lithium bis-trifluoromethanesulfonylimide (known under the acronym of Lilm) and mixtures thereof.

The lithium salt may be comprised in the electrolyte, in an amount from 0.3M to 2M.

As an organic solvent belonging to the family of carbonate solvents, mention may be made of ethylene carbonate (known under the acronym of EC), propylene carbonate (known under the acronym of PC), dimethyl carbonate (known under the acronym of DMC), diethyl carbonate (known under the acronym of DEC) and mixtures thereof.

As an organic solvent belonging to the family of lactone solvents, mention may be made of γ-butyrolactone, γ-valerolactone, δ-valerolactone, ε-caprolactone, γ-caprolactone.

As an organic solvent belonging to the family of sulfone solvents, mention may be made of ethylmethylsulfone (known under the acronym of EMS), trimethylenesulfone (known under the acronym of TriMS), 1-methyltrimethylenesulfone (known under the acronym of MTS), ethyl-sec-butylsulfone (known under the acronym of EiBS), ethyl-iso-propylsulfone (known under the acronym of EiPS) and also 3,3,3-trifluoropropylmethylsulfone (known under the acronym of FPMS).

The solvent may be used as a single solvent or as a mixture of distinct solvents which may thereby form a binary solvent or a ternary solvent.

For example, this may be simply EC, a binary solvent EC/EMC (1:1) or a ternary solvent which may comprise three solvents in proportions of (1:1:1) to (1:8:1) or (8:1:1) or further (1:1:8), a specific example being the ternary solvent EC/PC/DMC (1:1:3).

As a stabilization additive, mention may be made, when the latter is a phosphate compound, of tris(hexafluoroisopropyl)phosphate (known under the acronym of HFiP).

As a stabilization additive, mention may be made, when the latter is an anhydride compound, of ethanoic anhydride, propanoic anhydride, benzoic anhydride, butanoic anhydride, cis-butenedioic anhydride, butane-1,4-dicarboxylic anhydride, pentane-1,5-dicarboxylic anhydride, hexane-1,6-dicarboxylic anhydride, 2,2-dimethylbutane-1,4-dicarboxylic anhydride, 2,2-dimethylpentane-1,5-dicarboxylic anhydride, 4-bromophthalic anhydride, 4-chloroformylphthalic anhydride, phthalic anhydride, benzoglutaric anhydride and mixtures thereof.

This additive may be present in the electrolyte in an amount from 0.01% to less than 30% by mass based on the total mass of the electrolyte.

The aforementioned liquid electrolyte may be led, in the electrochemical cells of the storage batteries of the invention, to impregnate a separator, which is positioned between the positive electrode and the negative electrode of the electrochemical cell.

This separator may be in a porous material able to receive the liquid electrolyte in its porosity.

This separator may consist in a membrane in a material selected from glass fiber, a polymeric material (such as polyethylene, polypropylene or a mixture of both of them).

The electrolyte may also be an ionic liquid.

The electrolyte may also consist in a solid electrolyte, for example a ceramic membrane conducting lithium ions, conventionally called LISICON (corresponding to Lithium Super Ionic Conductor), this ceramic membrane may be of the perovskite type, such as (La,Li)TiO₃ (known under the acronym of LLTO), of the garnet type, such as Li₅La₃Ta₂O₁₂, Li₆La₃Zr₂O_{11.5}, of the phosphate type, such as Li₁₊ₓAlₓGe₂₋ₓ(PO₄)₃ with 0<x<0.8 (known under the acronym of LAGP) and Li₁₊ₓTi₂₋ₓAlₓ(PO₄)₃ with 0.25<x<0.3/Li_{1+x-y}Ti₂₋ₓAlₓSi_{y} (PO₄)_{3-y} with 0.2<x<0.25 and 0<y<0.05 (known under the acronym of LTAP), this membrane being particularly stable in the presence of a lithium insertion material of the positive electrode, while it is not stable in the presence of lithium metal.

The storage battery of the invention may be included in a sealed enclosure supplied with oxygen for its operation.

A storage battery specific to the invention is a storage battery comprising at least one electrochemical cell comprising:
a negative electrode comprising a nickel grid used as a support for a composition comprising carbon black (acting as an electron conducting material), PVDF (acting as a binder) and manganese oxide (acting as a catalyst), the manganese oxide may appear in the form of nanowires;
a positive electrode comprising an aluminum grid acting as a support, on which is deposited a composition comprising a material of formula LiMn_{1.5}Ni_{0.5}O₄ (acting as a lithium insertion material), carbon black (acting as an electron conducting material), PVDF (acting as a binder) and carbon fibers (acting as electron conducting fibers); and
a porous separator positioned between said negative electrode and said positive electrode, said separator being impregnated with an electrolyte comprising a lithium salt LiPF₆ in a mixture of EC/PC/DMC solvents under volume proportions of (1:1:3).

The storage batteries of the invention may be made by conventional techniques within the reach of one skilled in the art, for example by stacks of various constitutive elements of the storage battery (i.e., a negative electrode, a positive electrode and a separator), this stack being maintained in a casing.

The positive electrode and the negative electrode may be prepared beforehand, before their incorporation into the storage battery; this preparation may consist for each of these electrodes in the succession of the following steps:
a step for preparing the electrode composition (for example, for the negative electrode, a composition comprising an electron conducting material, an organic binder, a catalyst and for the positive electrode, a composition comprising a lithium insertion material, an organic binder, an electron conducting material);
a step for depositing these compositions on a support, for example a metal grid.

More specifically, the preparation of an accumulator according to the invention may comprise:
a step for positioning a positive electrode in a casing lid;
a step for stacking on the positive electrode a separator;
a step for stacking on the separator a negative electrode;
a step for positioning a casing lid on the negative electrode, so as to secure the different elements of the storage battery.

The invention will now be described, with reference to the following examples, given as an indication but not as a limitation.

### SHORT DESCRIPTION OF THE DRAWINGS

FIG. 1 is a view illustrating the mounting of a storage battery according to the invention, in accordance with Example 1 described below.

FIG. 2 illustrates the curve of the first charging of the storage battery obtained according to example 1, this curve illustrating the time-dependent change of the potential V (in V) depending on the capacity C (in mAh/g).

FIG. 3 illustrates the curve illustrating two charging/discharging cycles of the storage battery obtained according to Example 2, this curve illustrating the time-dependent change of the potential V (in V) depending on the capacity C (in mAh/g).

### DETAILED DISCUSSION OF PARTICULAR EMBODIMENTS

### EXAMPLE 1

The following example illustrates the preparation of a lithium-air storage battery including a negative air electrode (anode) and a positive electrode including a material with a high potential (which is expressed relatively to the Li⁺/Li pair) and a specific electrolyte.

The preparation of this storage battery comprises:
the manufacturing of the negative electrode (step a);
the manufacturing of the positive electrode (step b);
the manufacturing of the electrolyte (step c); and
the assembling of the storage battery (step d).

a) Manufacturing the Negative Electrode

0.85 g of Super C65 carbon are mixed with 24.5 g of N-methyl-2-pyrrolidone (known under the acronym of NMP), 0.426 g of polyvinylidene fluoride (known under the acronym of PVDF) and 0.14 g of manganese oxide nanowires in the a phase, in return for which an ink is obtained. This ink is then coated on a nickel grid with a height of 200 μm. The assembly resulting from this coating is dried in an oven at 60° C. for 24 hours. A negative electrode is made by means of a cylindrical punch with a diameter of 14 mm. Once it is obtained, this electrode is then dried in vacuo and at 80° C. for 48 hours.

b) Manufacturing the Positive Electrode 0.476 g of LiMn_{1.5}Ni_{0.5}O₄, 0.016 g of Super C65 carbon, 0.016 g of carbon fibers and 0.027 g of polyvinylidene fluoride are mixed into 2.5 g of N-methyl-2-pyrrolidone (known under the acronym of NMP) for 20 minutes, in return for which an ink is obtained. This ink is then coated on an aluminum grid and then the resulting assembly is dried in an oven at 60° C. for 24 hours. An electrode is made by means of a cylindrical punch with a diameter of 14 mm. Once it is obtained, this electrode is then dried in vacuo and at 80° C. for 48 hours. The capacity of the obtained electrode is 0.83 mAh.

c) Manufacturing the Electrolyte

The electrolyte is prepared by mixing in a glove box 100 mL of ethylene carbonate, 100 mL of propylene carbonate and 300 mL of dimethyl carbonate, to which are added 151.9 g of LiPF₆. The mixture is homogenized by stirring for 72 hours.

d) Assembling the Cell

The storage battery was assembled in a glove box filled with argon comprising an oxygen and water proportion of less than 0.1 ppm.

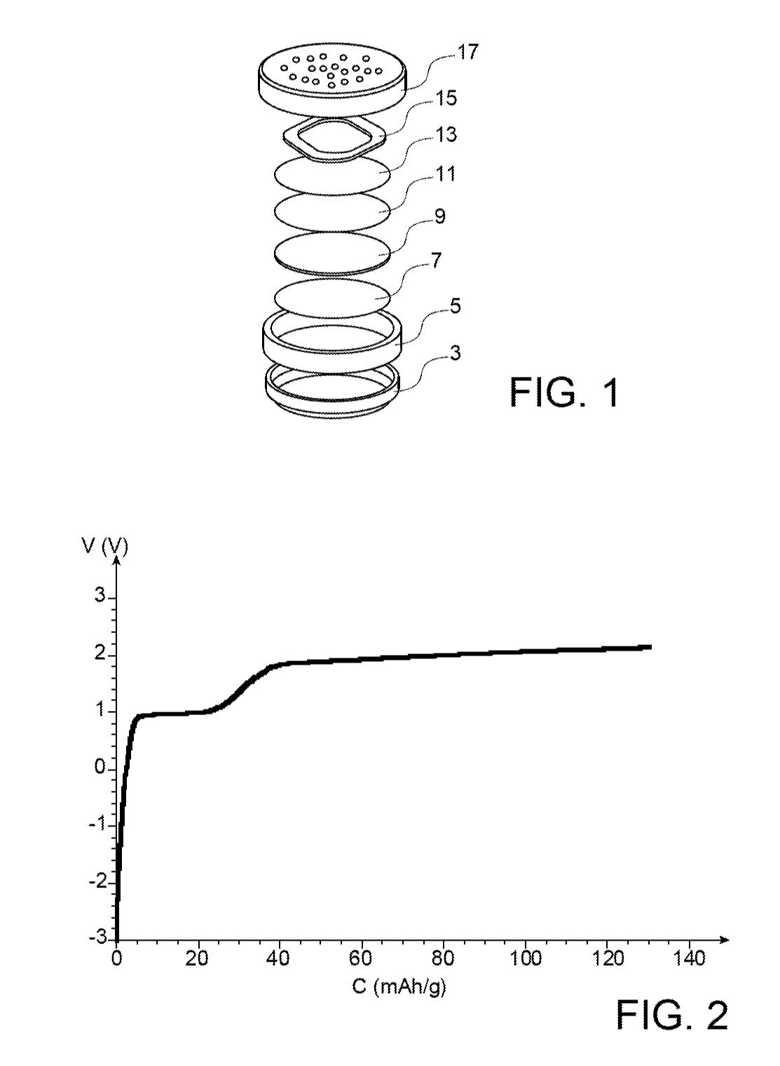

The storage battery was made as illustrated in FIG. 1 enclosed as an appendix, by starting with the positive electrode and then finishing with the negative electrode, the different elements of the storage battery being the following in this order:
a casing bottom 3;
a seal gasket 5;

a positive electrode 7;
a disc of Viledon 9 (which is a membrane in non-woven fibers of polyolefins (polypropylene/polyethylene) and a disc of Calgard 11 (which is a polypropylene membrane));
a negative electrode 13;
a spring 15; and
a lid 17.

The electrolyte impregnates both aforementioned discs in an amount of 150 μL.

The resulting storage battery is subject to a cycling test.

To do this, the storage battery was introduced into a sealed glass enclosure, in which a flow of pure oxygen at a pressure of 1 atmosphere allows good exposure of the storage battery to oxygen.

The positive and negative terminals of the storage battery are then connected to a battery test system (potentiostat, galvanostat). The storage battery was subject to a charging cycle at C/20 (0.041 mA) up to 2.15 V as illustrated in the appended FIG. 2.

### EXAMPLE 2

Example 2 again uses the same conditions as Example 1 to within a few exceptions.

In order to make the air anode, 0.300 g of Super C65 carbon, 9.8 g of N-methyl-2-pyrrolidone, 0.150 g of polyvinylidene fluoride and 0.10 g of manganese oxide nanowires in the alpha phase are mixed for 15 minutes.

The positive electrode, as for it, is manufactured under conditions similar to those of Example 1, except for the respective amounts of the reagents, which are the following: 0.531 g of LiMn_{1.5}Ni_{0.5}O₄, 0.018 g of Super C65 carbon, 0.018 g of carbon fibers and 0.030 g of polyvinylidene fluoride.

The capacity of the electrode is 1.1511 mAh.

The electrolyte and the assembly of the cell are similar in all points to the Example 1 mentioned above.

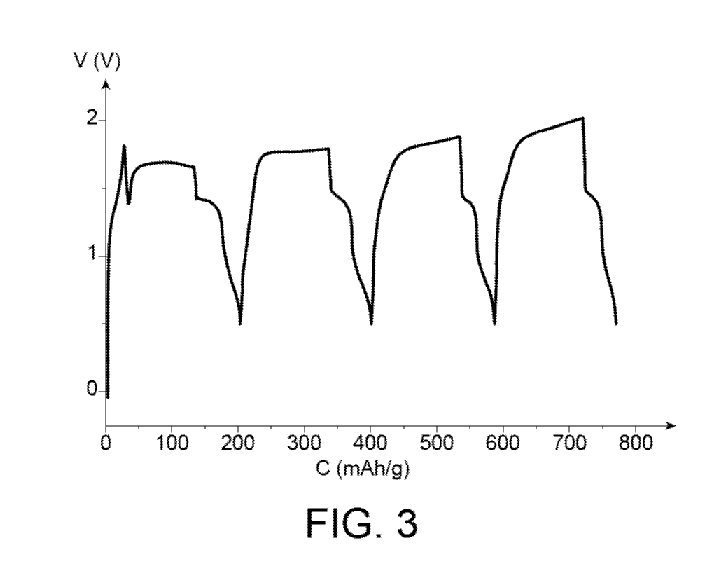

The cell was subject to 4 charging/discharging cycles between 1.6 V and 0.56 V at C/20 (0.057 mA) as illustrated in the appended FIG. 3, the 4 curves illustrating these cycles being similar.

1-26. (canceled)

27. A lithium-air storage battery comprising:
at least one electrochemical cell comprising
a negative electrode which is an air electrode;
a positive electrode which comprises a lithium insertion material; and
an organic electrolyte conducting lithium ions positioned between said negative electrode and said positive electrode,
wherein said electrolyte is constructed to not degrade when subject to a voltage ranging from 3V to 5.5V expressed relatively to the Li⁺/Li pair, and
wherein said storage battery has a potential difference between an electrochemical potential of the positive electrode and an electrochemical potential of the negative electrode greater than 4.5V expressed relatively to the Li⁺/Li pair.

28. The lithium-air storage battery according to claim 27, wherein the negative electrode comprises:
at least one electron conducting material;
at least one catalyst.

29. The lithium-air storage battery according to claim 28, wherein the electron conducting material is selected from carbonaceous materials and electron conducting ceramics.

30. The lithium-air storage battery according to claim 29, wherein the carbonaceous material is selected from graphite, mesocarbon beads, carbon fibers, carbon black, grapheme, and mixtures thereof.

31. The lithium-air storage battery according to claim 29,
wherein the electron conducting ceramic is selected from nitrides of transition elements, carbides of transition elements or of metalloid elements, carbonitrides of transition elements, and simple oxides of transition elements.

32. The lithium-air storage battery according to claim 28, wherein the catalyst is selected from:
catalysts consisting of a noble metal at oxidation degree 0 or an alloy of a noble metal and of another metal element;
a catalyst comprising a simple ruthenium oxide, a simple manganese oxide, a simple iron oxide, a simple cobalt oxide, or a simple copper oxide;
catalysts comprising a mixed cobalt oxide, a mixed manganese oxide, a mixed nickel oxide; and
mixtures thereof.

33. The lithium-air storage battery according to claim 28, wherein the catalyst is a mixed or simple manganese oxide, a mixed or simple iron oxide, a mixed or simple iron oxide, or mixtures thereof.

34. The lithium-air storage battery according to claim 28, wherein the binder is a polymeric binder.

35. The lithium-air storage battery according to claim 34, wherein the polymeric binder is selected from fluorinated (co)polymers.

36. The lithium-air storage battery according to claim 35, wherein the polymeric binder is a fluorinated polymer selected from polytetrafluoroethylene, polyvinylidene fluoride, and mixtures thereof.

37. The lithium-air storage battery according to claim 35, wherein the fluorinated (co)polymers conduct protons, elastomeric polymers, polymers from the family of polyvinyl alcohols, cellulose polymers, and mixtures thereof.

38. The lithium-air storage battery according to claim 27, wherein the negative electrode comprises a support in a material comprising a metal or a metal alloy or in a carbonaceous material.

39. The lithium-air storage battery according to claim 28,
wherein the negative electrode comprises a grid or foam in nickel used as a support for a composition comprising carbon black acting as an electron conducting material, polyvinylidene fluoride acting as a binder, and manganese oxide acting as a catalyst.

40. The lithium-air storage battery according to claim 39, wherein the manganese oxide is provided in the form of nanowires.

41. The lithium-air storage battery according to claim 27, wherein the lithium insertion material is a lithiated material with a spinel structure.

42. The lithium-air storage battery according to claim 41, wherein the material with a spinel structure is selected from:
materials of formula LiM¹PO₄, wherein M¹ is a transition element;
materials of formula LiM²SO₄X¹, wherein M² is a transition element and X¹ is a halogen element;
materials of formula Li₂M³PO₄X², wherein M³ is a transition element and X² is a halogen element, materials of this type may be Li₂CoPO₄F, Li₂NiPO₄F; and
materials of formula LiMn₂₋ₓM⁴ₓO₄, wherein M⁴ is a transition element selected from Ni, Fe, Co and mixtures thereof and x is comprised between 0.5 and 1, a material of this type may be LiMn_{1.5}Ni_{0.5}O₄.

43. The lithium-air storage battery according to claim 42, wherein the materials of formula LiM¹PO₄ are LiCoPO₄ or LiNiPO₄.

44. The lithium-air storage battery according to claim 42, wherein the materials of formula LiM²SO₄X¹ are LiCoSO₄F or LiNiSO₄F.

45. The lithium-air storage battery according to claim 42, wherein the materials of formula Li₂M³PO₄X² are Li₂CoPO₄F or Li₂NiPO₄F.

46. The lithium-air storage battery according to claim 42, wherein the materials of formula LiMn₂₋ₓM⁴ₓO₄ are LiMn_{1.5}Ni_{0.5}O₄.

47. The lithium-air storage battery according to claim 27, wherein the positive electrode further comprises:
at least one electron conducting material; and
at least one binder for ensuring the cohesion between said lithium insertion material and said electron conducting material

48. The lithium-air storage battery according to claim 47, further comprising electron conducting fibers.

49. The lithium-air storage battery according to claim 47, wherein the electron conducting material is a carbonaceous material.

50. The lithium-air storage battery according to claim 47, wherein the binder is a polymeric binder.

51. The lithium-air storage battery according to claim 50, wherein the polymeric binder is selected from fluorinated (co)polymers.

52. The lithium-air storage battery according to claim 51, wherein the fluorinated (co)polymers conduct protons, elastomeric polymers, polymers from the family of polyvinyl alcohols, and mixtures thereof.

53. The lithium-air storage battery according to claim 47, wherein the electron conducting fibers are carbon fibers.

54. The lithium-air storage battery according to claim 27, wherein the positive electrode comprises a support in a material comprising a metal or a metal alloy or in a carbonaceous material.

55. The lithium-air storage battery according to claim 27,
wherein the positive electrode comprises an aluminum grid acting as a support, on which is deposited a composition comprising a material of formula LiMn_{1.5}Ni_{0.5}O₄ acting as a lithium insertion material, carbon black acting as an electron conducting material, polyvinylidene fluoride acting as a binder, and carbon fibers acting as electron conducting fibers.

56. The lithium-air storage battery according to claim 27, wherein the electrolyte comprises:
at least one lithium salt; and
at least one organic solvent belonging to the family of carbonate solvents or sulfone solvents or lactone solvents.

57. The lithium-air storage battery according to claim 56, further comprising a stabilization additive belonging to the family of phosphate or anhydride compounds.

58. The lithium-air storage battery according to claim 56, wherein the lithium salt is selected from the group formed by LiPF₆, LiClO₄, LiBF₄, LiAsF₆, LiCF₃SO₃, LiN(CF₃SO₂)₃, LiN(C₂F₅SO₂), lithium bistrifluoromethylsulfonylimide (LiTFSI) LiN[SO₂CF₃]₂, lithium bis(oxalato)borate (LIBOB), lithium bis(fluorosulfonyl)imide (LiFSI), LiPF₃(CF₂CF₃)₃ (LiFAP), lithium trifluoromethanesulfonate (LiTf), lithium bis-trifluoromethanesulfonylimide (Lilm), and mixtures thereof.

59. The lithium-air storage battery according to claim 56, wherein the carbonate solvent is selected from ethylene carbonate, propylene carbonate, dimethyl carbonate, diethyl carbonate, or mixtures thereof.

60. The lithium-air storage battery according to claim 27, wherein the liquid electrolyte impregnates a separator in a porous material.

61. A lithium-air storage battery, comprising:
at least one electrochemical cell comprising
a negative electrode comprising a nickel grid used as a support for a composition comprising carbon black acting as an electron conducting material, polyvinylidene fluoride acting as a binder and manganese oxide acting as a catalyst;
a positive electrode comprising an aluminum grid acting as a support, on which is deposited a composition comprising a material of formula LiMn_{1.5}Ni_{0.5}O₄ acting as a lithium insertion material, carbon black acting as an electron conducting material, polyvinylidene fluoride acting as a binder, and carbon fibers acting as electron conducting fibers; and
a porous separator positioned between said negative electrode and said positive electrode, said separator being impregnated with an electrolyte comprising a lithium salt LiPF₆ in a mixture of EC/PC/DMC solvents in volume proportions of (1:1:3).

62. The lithium-air storage battery according to claim 61, wherein the manganese oxide is provided in the form of nanowires.

63. The lithium-air storage battery according to claim 28, further comprising at least one binder for ensuring the cohesion between said material and said catalyst.
